(19) United States
(12) Patent Application Publication
(10) Pub. No.: US 2011/0063207 A1
(43) Pub. Date: Mar. 17, 2011

(54) DISPLAY APPARATUS AND CONTROL METHOD THEREOF AND PROJECTION APPARATUS AND CONTROL METHOD THEREOF

(75) Inventor: Tzung-Yuan Lee, Taichung County (TW)

(73) Assignee: NOVATEK MICROELECTRONICS CORP., Hsinchu (TW)

(21) Appl. No.: 12/776,431

(22) Filed: May 10, 2010

(30) Foreign Application Priority Data
Sep. 16, 2009 (TW) 98131246

(51) Int. Cl. G09G 5/00; G09G 5/10

(52) U.S. Cl. 345/156; 345/690

(57) ABSTRACT

A display apparatus including at least one sensor, a processing unit and a control unit is provided. The sensor senses a human body. The processing unit is coupled to the sensor, and captures and processes signals from the sensor to obtain a sensing data. The control unit is coupled to the processing unit, and analyzes and determines whether the human body is to enter into or to be distant from a sensing range of the sensor according to the sensing data. When the control unit determines that the human body is to be distant from the sensing range for a first predetermined time, the control unit turns off the display apparatus or makes the display apparatus get into a power-saving/sleeping mode. When the control unit determines that the human body is to enter into the sensing range for a second predetermined time, the control unit turns on the display apparatus.

### CROSS-REFERENCE TO RELATED APPLICATION

This application claims the priority benefit of Taiwan application serial no. 98131246, filed on Sep. 16, 2009. The entirety of the above-mentioned patent application is hereby incorporated by reference herein and made a part of specification.

### BACKGROUND OF THE INVENTION

1. Field of the Invention

The invention relates to a detection control technology, and more particularly, to an electronic apparatus with a sensor and a control method thereof.

2. Description of Related Art

Generally, there are two power-saving schemes of the display apparatus in the art. One is that when the display apparatus is in use, an analysis is done according to the intensity of the ambient light or the characteristic of the image content to adjust the brightness of the display module of the entire display apparatus so as to save the power; another is that the display apparatus is not in use, it counts with the counter therein, then no operation is detected for a period of time, thereby the display apparatus automatically is turned off or the display apparatus is made to get into the power-saving/sleeping mode to save the power.

Besides, some display apparatuses further detect whether a signal is input from the input source of the image signal or detect whether the image content is updated or not. When the display apparatus discovers that no signal is input from the input source of the image signal for a period of time, invalid signal is input, or there is no update of the image content, thereby the display apparatus automatically is turned off or is made to get into the power-saving/sleeping mode to save the power.

However, the schemes described above are effective, some problems will be met in practice as shown below, for example:

1. some users read with the display apparatus (along with computers or other electronic devices). When the users read and think, no operation to the computers or the other electronic devices which are connected to the display apparatus is made. Therefore, the frame of the display apparatus may be the same. Therefore, due to the lack of the operation or no update of the image content for a period of time, the display apparatus is automatically turned off or is made to get into the power-saving/sleeping mode while the user is still watching.

2. some users watch the cartoons or the movies with the display apparatus (along with computers or other electronic devices). During watching, no operation to the computers or the other electronic devices which are connected to the display apparatus is made for a longer time. Therefore, it often causes the display apparatus to get into the power-saving/sleeping mode.

As described above, most manufacturers or users set the detection duration (usually several minutes, even several hours) to solve such problem. However, if the duration is too short, due to the power-saving scheme, the display apparatus is automatically turned off or is made to get into the power-saving/sleeping mode while the user is watching the display apparatus. If the duration is too long, the performance of power-saving helps little.

### SUMMARY OF THE INVENTION

Accordingly, an embodiment of the invention provides a display apparatus which includes at least one sensor, a processing unit, and a control unit. The sensor detects a human body. The processing unit is coupled to the sensor, and captures and processes a signal SS from the sensor to obtain the sensing data. The control unit is coupled to the processing unit, and analyzes and determines whether the human body is to enter into or to be distant from a sensing range of the sensor according to the sensing data. When the control unit determines that the human body is to be distant from the sensing range for more than a first predetermined time, the display apparatus is turned off or the display apparatus is made to get into the power-saving/sleeping mode; when the control unit determines that the human body is to enter into the sensing range for more than a second predetermined time, the display apparatus is turned on. The sensing range can be determined by the user, the manufacturer, or the predetermined software and hardware architecture of product itself.

Another embodiment of the invention provides a method for controlling the display apparatus including determining whether a human body is to enter into or to be distant from a sensing range of the display apparatus. When determining that the human body is to be distant from the sensing range for a first predetermined time, turning off the display apparatus, making the display apparatus get into a power-saving/sleeping mode, or adjusting the brightness of the display apparatus to a even lower level; when determining that the human body is to enter into the sensing range for a second predetermined time, turning on the display apparatus. The sensing range can be determined by the user, the manufacturer, or the predetermined software and hardware architecture of product itself.

An embodiment of the invention further provides a projection apparatus which includes a projection light source, at least one sensor, a processing unit, and a control unit. The sensor detects a projection surface when the projection apparatus is turned on. The processing unit is coupled to the sensor, and captures and processes a signal from the sensor to obtain the sensing data. The control unit is coupled to the processing unit and the projection light source, and analyzes and determines a distance between the projection apparatus and the projection surface according to the sensing data. A brightness of the projection light source is adjusted according to the distance when the distance is within a predetermined distance range for a first predetermined time; and the projection apparatus is made to be turned off, to get into a power-saving/sleeping mode, to get into a standby mode, to turn off the projection light source, or to set the projection light source at a specific brightness when the control unit determines that the distance exceeds the predetermined distance range for a second predetermined time. The sensing range can be determined by the user, the manufacturer, or the predetermined software and hardware architecture of product itself.

An embodiment of the invention also provides a method for controlling a projection apparatus including a projection light source. The method includes determining a distance between the projection apparatus and a projection surface when the projection apparatus is turned on. when determining that the distance is within a predetermined distance range for a first predetermined time, controlling a brightness of the projection light source according to a length of the distance; and when determining that the distance exceeds or is smaller than the predetermined distance range for a second predetermined time, making the projection apparatus to be turned off, to get into a power-saving/sleeping mode, to get into a standby mode, to turn off the projection light source or to set the projection light source at a specific brightness. The sensing range can be determined by the user, the manufacturer, or the predetermined software and hardware architecture of product itself.

It should be understood that the description above and the embodiment below is merely exemplary and explanatory without limiting the scope or the spirit of the invention

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a diagram of the front of a display apparatus according to an embodiment of the invention.

FIG. 2 shows a diagram of the relative relationship between a display apparatus and a user according to an embodiment of the invention.

FIG. 3 shows a block diagram of the inside of a display device according to an embodiment of the invention.

FIG. 4 shows a method for controlling the display apparatus according to an embodiment of the invention.

FIG. 5 shows a diagram of the front of a projection apparatus according to an embodiment of the invention.

FIG. 6 shows a diagram of the relative relationship between a projection apparatus and a projection surface according to an embodiment of the invention.

FIG. 7 shows a block diagram of the inside of a projection apparatus according to an embodiment of the invention.

FIG. 8 shows a method for controlling the projection apparatus according to an embodiment of the invention.

### DESCRIPTION OF EMBODIMENTS

Reference will now be made in detail to the embodiments of the invention, examples of which are illustrated in the accompanying drawings. Wherever possible, the same reference numbers are used in the drawings and the description to refer to the same or like parts.

### For the Display Apparatus

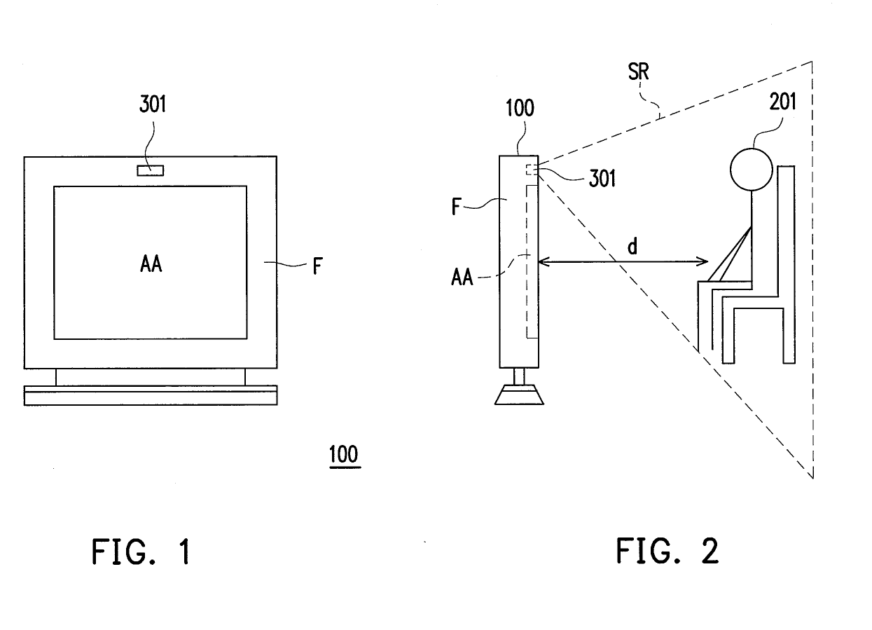

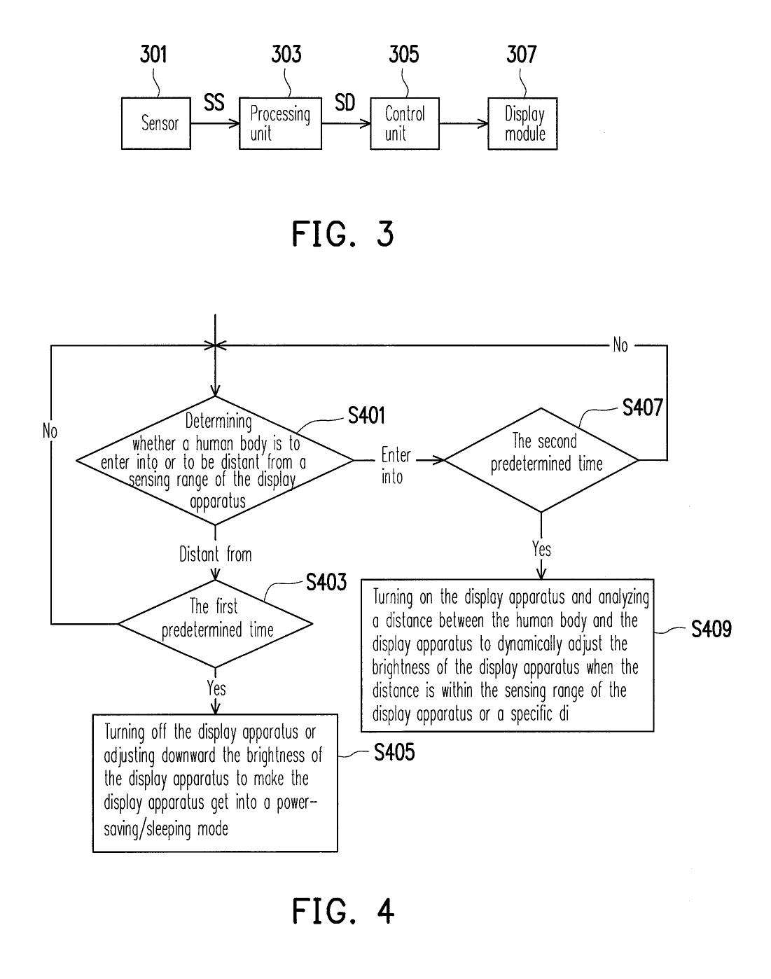

FIG. 1 shows a diagram of the front of a display apparatus according to an embodiment of the invention. FIG. 2 shows a diagram of the relative relationship between a display apparatus and a user according to an embodiment of the invention. FIG. 3 shows a block diagram of the inside of a display apparatus according to an embodiment of the invention. Referring to FIGS. 1 to 3, the display apparatus 100 includes at least one sensor 301, a processing unit 303, a control unit 305, and a display module 307.

The sensor 301 may be mounted at the upper side of the front edge F of the display apparatus 100 (but not limited thereto) for detecting a human body 201 (that is, the user). In the embodiment, the sensor 301 may be an optical sensor, an ultrasonic wave sensor, an electromagnetic wave sensor, a mechanical wave, a temperature sensor, or an image sensor, but not limited thereto. The number and the position of the sensor 301 mounted at the front edge F of the display apparatus 100 may be determined according to the requirement of the actual design.

The processing unit 303 is coupled to the sensor 301, and captures and processes a signal SS from the sensor 301 to obtain a sensing data SD. The control unit 305 is coupled between the processing unit 303 and the display apparatus 307, and analyzes and determines whether the human body 201 is to enter into or to be distant from a sensing range SR of the sensor 301 according to the sensing data SD, wherein the sensing range SR of the sensor 301 may be obtained according to the characteristic of the sensor 301, and may be determined by the user, the manufacturer, or the predetermined software and hardware architecture of product itself.

In the embodiment, when the control unit 305 determines that the human body 201 is to be distant from the sensing range SR of the sensor 301 for a first predetermined time (the first predetermined time may be a constant time or a variable time to be tuned by the user) according to the sensing data SD obtained by the processing unit 303, the control unit 305 turns off the display apparatus 100 or makes the display apparatus 100 get into a power-saving/sleeping mode.

On the other hand, when the control unit 305 determines that the human body 201 is to enter into the sensing range SR of the sensor 301 for a second predetermined time (the second predetermined time may also be a constant time or a variable time to be tuned by the user) according to the sensing data SD obtained by the processing unit 303, the control unit 305 turns on the display apparatus 100 and makes the display module 307 display images in the display region AA for the user watching.

Accordingly, once the user is to enter into the sensing range SR of the sensor 301 for the second predetermined time, the control unit 305 turns on the display apparatus 100. Therefore, when the user reads and watches the cartoons or the movies with the display apparatus 100 (along with computers or other electronic devices), as long as the user keeps being to enter into the sensing range SR of the sensor 301 for the second predetermined time, the control unit 305 makes the display apparatus 100 be in the normal operation mode without turning off by oneself or entering the power-saving/sleeping mode so that the problems described in the background of the invention can be mended.

In addition, once the user is to be distant from the sensing range SR of the sensor 301 for the first predetermined time, the control unit 305 turns off the display apparatus 100 or adjusts downward the brightness of the display module 307 to make the display apparatus 100 get into the power-saving/sleeping mode. Therefore, when the user reads and watches the cartoons or the movies with the display apparatus 100 (along with computers or other electronic devices), and the user is to be distant from the sensing range SR of the sensor 301 for at least the first predetermined time, the control unit 305 turns off the display apparatus 100 or makes the display apparatus 100 get into the power-saving/sleeping mode so as to achieve the purpose of power saving.

In another embodiment of the invention, the control unit 305 may further analyze and determine the distance d between the human body 201 and the sensor 301 according to the sensing data SD, and accordingly adjust the brightness of the display module 307. In the embodiment, the display module 307 generally consists of the display panel, the backlight module and several drivers. Thus, when the control unit 305 determines that the distance d between the human body 201 and the sensor 301 is within the sensing range SR of the sensor 301 or within a specific distance range according to the sensing data SD obtained by the processing unit 303, the brightness of the display module 307 can be dynamically adjusted (for example, gradually increased such as linear or non-linear increased, but not limited thereto) by image processing, Gamma voltage adjustment, gray level voltage adjustment, or backlight brightness adjustment (but not limited thereto) according to the distance d.

On the other hand, when the control unit 305 determines that the distance d between the human body 201 and the sensor 301 exceeds the sensing range SR of the sensor 301 according to the sensing data SD obtained by the processing unit 303, the brightness of the display module 307 can be dynamically adjusted (for example, gradually decreased such as linear or non-linear decreased, but not limited thereto) by image processing, Gamma voltage adjustment, gray level voltage adjustment, or backlight brightness adjustment (but not limited thereto) until the display apparatus 100 is turned off or gets into the power-saving/sleeping mode.

Based on the description in such embodiment, FIG. 4 shows a method for controlling a display apparatus according to an embodiment of the invention. Referring to FIG. 4, the method for controlling the display apparatus in the embodiment includes determining whether a human body is to enter into or to be distant from a sensing range of the display apparatus (Step S401). When determining, in Step S401, that the human body is to be distant from the sensing range, then determining that the human body is whether to be distant from the sensing range for a first predetermined time (Step S403), wherein the first predetermined time may be a constant time or a variable time to be tuned by the user. When determining, in Step S403, that the human body is to be distant from the sensing range for or more than the first predetermined time, turning off the display apparatus or adjusting downward the brightness of the display apparatus to make the display apparatus get into a power-saving/sleeping mode (Step S405). In addition, when determining, in Step S403, that the human body is not to be distant from the sensing range for the first predetermined time, returning back to the Step S401.

On the other hand, when the human body is to enter into the sensing range of the sensor is determined in Step S405, then determining whether the human body is to enter into the sensing range of the display apparatus for at least a second predetermined time (Step S407), wherein the second predetermined time may be a constant time or a variable time to be tuned by the user. When the human body is to enter into the sensing range of the sensor for at least or more than the first predetermined time is determined in Step S407, turning on the display apparatus and analyzing a distance between the human body and the display apparatus to dynamically adjust the brightness of the display apparatus when the distance is within the sensing range of the display apparatus or a specific distance range (Step S409). In addition, when the human body is to enter into the sensing range of the display apparatus for less than the second predetermined time is determined in Step 407, returning back to the Step S401. In the present embodiment, the brightness of the display apparatus may be gradually increased when the distance between the human body and the display apparatus is within the sensing range or a specific distance range; moreover, the brightness of the display apparatus may be gradually decreased when the distance between the human body and the display apparatus exceeds the sensing range or the specific distance range, but all not limited thereto.

### For the Projection Apparatus

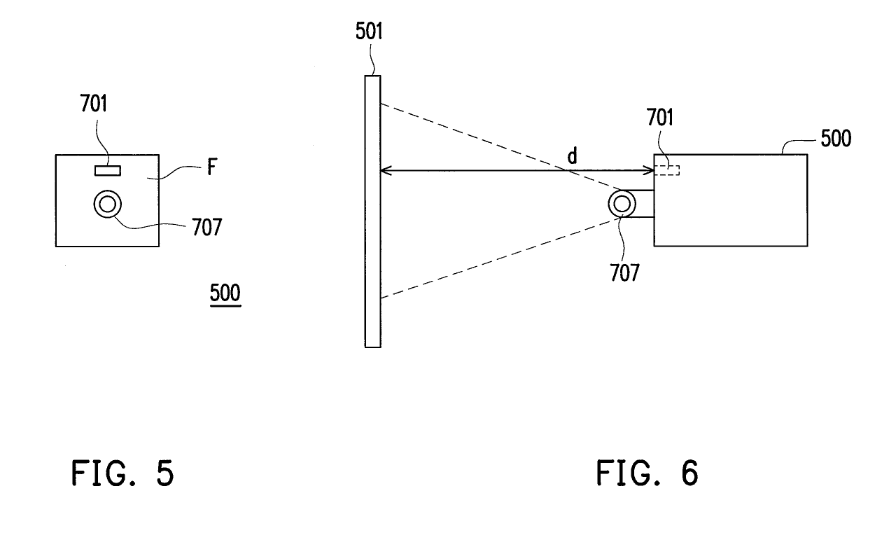

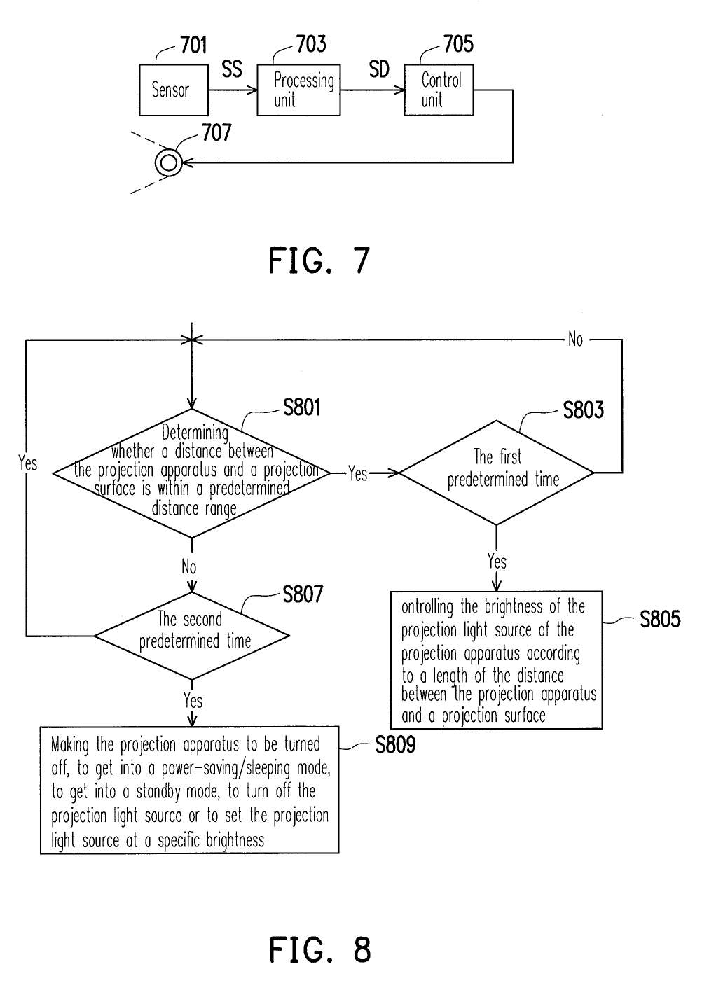

FIG. 5 shows a diagram of the front of a projection apparatus according to an embodiment of the invention. FIG. 6 shows a diagram of the relative relationship between a projection apparatus and a projection surface according to an embodiment of the invention. FIG. 7 shows a block diagram of the inside of a projection apparatus according to one embodiment of the invention. Referring to FIGS. 5 to 7, the projection apparatus 500 may be a projector, a single beam projector, a slide projector, or a theater movie projector, and includes at least one sensor 701, a processing unit 703, a control unit 705 and a projection light source 707.

The sensor 701 may be mounted at the upper side of the front edge F of the projection apparatus 500 (but not limited thereto) for detecting a projection surface 501 (for example, a screen, but not limited thereto) when the projection apparatus 500 is turned on. In the embodiment, the sensor 701 may be an optical sensor, an ultrasonic wave sensor, an electromagnetic wave sensor, a mechanical wave, a temperature sensor, or an image sensor, but all not limited thereto. Additionally, the number and the position of the sensor 701 mounted at the front edge F of the projection apparatus 500 can be determined according to the requirement of the actual design.

The processing unit 703 is coupled to the sensor 701, and captures and processes a signal SS from the sensor 701 to obtain the sensing data SD. The control unit 705 is coupled to the processing unit 703 and the projection light source 707, and analyzes and determines the distance d between the projection apparatus 500 and the projection surface 501 according to the sensing data SD obtained by the processing unit 703. In the embodiment, when the control unit 705 determines that the distance d between the projection apparatus 500 and the projection surface 501 is within a predetermined distance range for a first predetermined time (the first predetermined time may be a constant time or a variable time to be tuned by the user, in addition, the predetermined distance range may be determined according to actual situation) according to the sensing data SD obtained by the processing unit 703, the control unit 705 controls the brightness of the projection light source 707 according to the distance d between the projection apparatus 500 and the projection surface 501.

Herein, when the control unit 705 determines that distance d between the projection apparatus 500 and the projection surface 501 is within such predetermined distance range and the distance d is increasing more and more, the control unit 705 gradually increases (for example, linear or non-linear increases, but not limited thereto) the brightness of the projection light source 707. In addition, when the control unit 705 determines that distance d between the projection apparatus 500 and the projection surface 501 is within such predetermined distance range and the distance d is decreasing more and more, the control unit 705 gradually decreases (for example, linear or non-linear decreases, but not limited thereto) the brightness of the projection light source 707.

In the embodiment, the control unit 705 controls the brightness of the projection light source 707 by image processing, Gamma voltage adjustment, gray level voltage adjustment, projection light source brightness adjustment, or lens focus adjustment of the projection apparatus, but all not limited thereto.

On the other hand, when the control unit 705 determines that the distance d between the projection apparatus 500 and the projection surface 501 is greater than or less than such predetermined distance range for a second predetermined time (the second predetermined time also may be a constant time or a variable time to be tuned by the user) according to the sensing data SD obtained by the processing unit 703, the control unit 705 turns off the projection apparatus 500 or makes the projection apparatus 500 get into the power-saving/sleeping mode, get into a standby mode, turn off the projection light source 707, or set the projection light source 707 at a specific brightness.

Accordingly, once the distance d between the projection apparatus 500 and the projection surface 501 is within such predetermined distance range for the first predetermined time, the control unit 705 adaptively adjusts the brightness of the projection light source 707 according to the distance d between the projection apparatus 500 and the projection surface 501. Therefore, when the user reads and watches the cartoons or the movies with the projection apparatus 500 (along with computers or other electronic devices), as long as the distance d between the projection apparatus 500 and the projection surface 501 is within such predetermined distance range for the first predetermined time, the control unit 705 makes the projection apparatus 500 be in the normal operation mode without turning off by oneself or entering the power-saving/sleeping/standby mode.

Additionally, once the distance d between the projection apparatus 500 and the projection surface 501 is greater than or less than such predetermined distance range for the second predetermined time, the control unit 705 turns off the projection apparatus 500 or makes the projection apparatus 500 get into the power-saving/sleeping mode, get into the standby mode, turn off the projection light source 707, or set the projection light source 707 at a specific brightness, so that it prevents the projection light source 707 from being burned-out and achieves the purpose of power saving.

Based on the description in such embodiment, FIG. 8 shows a method for controlling a projection apparatus according to an embodiment of the invention. Referring to FIG. 8, the method for controlling the projection apparatus in the embodiment includes determining whether a distance between the projection apparatus, including a projection light source, and a projection surface is within a predetermined distance range when the projection apparatus is turned on (Step S801). When determining, in the Step S801, that the distance between the projection apparatus and the projection surface is within a predetermined distance range, then determining the distance between the projection apparatus and the projection surface is whether within the predetermined distance range for a first predetermined time (Step S803), wherein the first predetermined time may be a constant time or a variable time to be tuned by the user.

When the distance between the projection apparatus and the projection surface is within the predetermined distance range for the first predetermined time is determined in Step S803, controlling the brightness of the projection light source according to a length of the distance (Step S805). Herein, when determining that the distance between the projection apparatus and the projection surface is within the predetermined distance range and the distance is increasing more and more, gradually increasing the brightness of the projection light source; and when determining that the distance between the projection apparatus and the projection surface is within the predetermined distance range and the distance is decreasing more and more, gradually decreasing the brightness of the projection light source. In addition, when the distance between the projection apparatus and the projection surface is not within the predetermined distance range for the first predetermined time is determined in Step S803, returning back to the Step S801.

On the other hand, when the distance between the projection apparatus and the projection surface is not within (that is, greater than or less than) the predetermined distance range is determined in Step S801, then determining whether the distance between the projection apparatus and the projection surface is greater than or less than the predetermined distance range for at least the second predetermined time (Step S807), wherein the second predetermined time may also be a constant time or a variable time to be tuned by the user. When determining, in the Step S807, that the distance between the projection apparatus and the projection surface is greater than or less than the predetermined distance range for at least the second predetermined time, making the projection apparatus to be turned off, to get into a power-saving/sleeping mode, to get into a standby mode, to turn off the projection light source or to set the projection light source at a specific brightness (Step S809). In addition, when determining, in the Step S807, that the distance between the projection apparatus and the projection surface is not greater than or less than the predetermined distance range for less than the second predetermined time, returning back to step S801.

Although the invention has been described with reference to the above embodiments, it is apparent to one of the ordinary skill in the art that modifications to the described embodiments may be made without departing from the spirit of the invention. Accordingly, the scope of the invention will be defined by the attached claims not by the above detailed descriptions.

What is claimed is:

1. A display apparatus, comprising:
at lease one sensor, generating a sensing signal, the sensing signal corresponds to a distance between a human body and the display apparatus;
a processing unit, coupled to the sensor, for processing the sensing signal to obtain a sensing data; and
a control unit, coupled to the processing unit, for analyzing and determining whether the human body is to enter into or to be distant from a sensing range of the sensor according to the sensing data, wherein when the control unit determines that the human body is to be distant from the sensing range for a first predetermined time, the control unit turns off the display apparatus or makes the display apparatus get into a power-saving/sleeping mode.

2. The display apparatus of claim 1, wherein when the control unit determines that the human body is to enter into the sensing range for a second predetermined time, the control unit turns on the display apparatus.

3. The display apparatus of claim 1, further comprising:
a display module, coupled to the control unit, wherein the control unit further controls a brightness of the display module.

4. The display apparatus of claim 3, wherein the control unit reduces the brightness of the display module to make the display apparatus get into the power-saving/sleeping mode.

5. The display apparatus of claim 1, wherein the control unit further analyzes the distance between the human body and the sensor according to the sensing data, and accordingly adjusts the brightness of the display module.

6. The display apparatus of claim 5, wherein when the control unit determines that the distance is within a specific distance range or the sensing range, the control unit dynamically adjusts the brightness of the display module according to the distance.

7. The display apparatus of claim 2, wherein each of the first and the second predetermined time is a constant time or a variable time.

8. The display apparatus of claim 1, wherein the sensor comprises an optical sensor, an optoelectronic sensor, an ultrasonic wave sensor, an electromagnetic wave sensor, a mechanical wave, a temperature sensor, or an image sensor.

9. A method for controlling a display apparatus, comprising:
determining whether a human body is to enter into or to be distant from a sensing range of the display apparatus, wherein:
turning off the display apparatus or making the display apparatus get into a power-saving/sleeping mode when determining that the human body is to be distant from the sensing range for a first predetermined time; and
turning on the display apparatus when determining that the human body is to enter into the sensing range for a second predetermined time.

10. The method of claim 9, wherein the step of making the display apparatus get into the power-saving/sleeping mode comprises:
reducing a brightness of the display module to make the display apparatus get into the power-saving/sleeping mode.

11. The method of claim 10, further comprising:
analyzing a distance between the human body and the display apparatus, and accordingly adjusting the brightness of the display apparatus.

12. The method of claim 11, wherein the brightness of the display apparatus is dynamically adjusted when determining that the distance is within the sensing range or a specific distance range.

13. The method of claim 9, wherein each of the first and the second predetermined time is a constant time or a variable time.

14. A projection apparatus, comprising:
a projection light source;
at least one sensor, generating a sensing signal when the projection apparatus is turned on, wherein the sensing signal corresponds to a distance between the projection apparatus and a projection surface;
a processing unit, coupled to the sensor, for capturing and processing the sensing signal to obtain a sensing data; and
a control unit, coupled to the processing unit and the projection light source, for analyzing and determining the distance between the projection apparatus and the projection surface according to the sensing data, wherein a brightness of the projection light source is adjusted according to the distance when the distance is within a predetermined distance range for a first predetermined time; and the projection apparatus is made to be turned off, to get into a power-saving/sleeping mode, to get into a standby mode, to turn off the projection light source, or to set the projection light source at a specific brightness when the control unit determines that the distance exceeds the predetermined distance range for a second predetermined time.

15. The projection apparatus of claim 14, wherein the brightness of the projection light source is increased when the control unit determines that the distance is within the predetermined distance range and the distance is increasing more and more.

16. The projection apparatus of claim 14, wherein the brightness of the projection light source is reduced when the control unit determines that the distance is within the predetermined distance range and the distance is decreasing more and more.

17. The projection apparatus of claim 14, wherein each of the first and the second predetermined time is a constant time or a variable time.

18. The projection apparatus of claim 14, wherein the sensor comprises an optical sensor, an optoelectronic sensor, an ultrasonic wave sensor, an electromagnetic wave sensor, a mechanical wave, a temperature sensor, or an image sensor.

19. The projection apparatus of claim 14, wherein the projection apparatus comprises a projector, a single beam projector, a slide projector, or a theater movie projector.

20. A method for controlling a projection apparatus, the projection apparatus comprises a projection light source, the method comprises:
determining a distance between the projection apparatus and a projection surface when the projection apparatus is turned on;
controlling a brightness of the projection light source according to a length of the distance, when determining that the distance is within a predetermined distance range for a first predetermined time; and
making the projection apparatus to be turned off, to get into a power-saving/sleeping mode, to get into a standby mode, to turn off the projection light source or to set the projection light source at a specific brightness when determining that the distance exceeds or is smaller than the predetermined distance range for a second predetermined time.

21. The method of claim 20, wherein the brightness of the projection light source is gradually increased when determining that the distance is within the predetermined distance range and the distance is increasing more and more.

22. The method of claim 20, wherein the brightness of the projection light source is gradually reduced when determining that the distance is within the predetermined distance range and the distance is decreasing more and more.

23. The method of claim 20, wherein each of the first and the second predetermined time is a constant time or a variable time.

24. An electronic apparatus, comprising:
an image device, displaying an image;
at least one sensor, generating a sensing signal, wherein the sensing signal corresponds to a distance between an object and the electronic apparatus;
a processing unit, coupled to the sensor, for capturing and processing the sensing signal from the sensor to obtain a sensing data; and
a control unit, coupled to the processing unit, for analyzing and determining the distance between the electronic apparatus and the object for controlling a brightness of the image displayed by the image device.
